(19) United States
(12) Patent Application Publication
(10) Pub. No.: US 2008/0045273 A1
(43) Pub. Date: Feb. 21, 2008

(54) Mobile Telephone Message Display Scheduling Device and Scheduling Method

(75) Inventor: Zhi Qiang Xue, Beijing (CN)

Correspondence Address: BELL, BOYD & LLOYD, LLP, P.O. BOX 1135, CHICAGO, IL, 60690, US

(73) Assignee: Siemens Home and office Communication Device Gmbh & cO., KG, Muenchen (DE)

(21) Appl. No.: 11/571,587

(22) PCT Filed: Jun. 29, 2005
(86) PCT No.: PCT/EP05/53056

§ 371 Date: Jan. 3, 2007

(30) Foreign Application Priority Data
Jun. 30, 2004 (CN) 200410062504.2

(51) Int. Cl. H04M 1/725

(52) U.S. Cl. 455/566

(57) ABSTRACT

A display scheduling device and a display method of a mobile telephone light emitting diode display system characterized wherein the display scheduling device includes a priority level grouping unit, a display queue unit, a timing queue unit, and a scheduling program unit. The scheduling program unit refers to mobile telephone state priority level groupings which are held in the priority level grouping unit and, by comparing the priority level of a currently occurring mobile telephone state with the priority level of a mobile telephone state which is at the head of a queue in the display queue unit, it can effect rational and effective scheduling with respect to random and concurrent mobile telephone state messages and cause these to be displayed in the mobile telephone's message display system, and, due to the use of the display queue unit and the timing queue unit, there is no loss of mobile telephone state messages which need to be displayed.

### FIELD OF TECHNOLOGY

The present disclosure relates to a scheduling device and scheduling method for a mobile telephone light-emitting diode (LED) message display system, which can provide the mobile telephone light-emitting diode message display system with rational and effective scheduling of displays of mobile telephone state messages.

### BACKGROUND

Accompanying the broadening applications and the ever-increasing ownership of various types of electronic products, people's daily lives are quietly changing, with desk-top and portable computers provide people with work and learning tools possessing improved functions, palm computers and personal data assistants (PDA) provide people with excellent detailed assistance, digital household electrical appliances provide people with a rich variety of facilities for living and entertainment, mobile communication user terminals provide people with fast and convenient communication systems, vehicle-mounted global positioning systems (GPS) provide people with convenient traffic directions for trips, and the use of these various types of electronic products is gradually becoming part of people's everyday lives.

The main systems employed for giving notifications of the states of an electronic product while people are using the above noted electronic products comprise message display screen indications and ringing tone or alerting sound indications. However, in some situations or circumstances, it may be unsuitable for the user to use a ringing tone or alerting sound indication, or it may not be easy for the user to directly view the content of a message which is displayed on a message display screen, and light-emitting diodes are therefore coming to be used more and more as supplementary message display devices for electronic products. As well as providing users with further message display systems which are clear at a glance, these light-emitting diode message display systems of electronic products also increase the attractiveness of electronic products thanks to the rich variety of their light emission effects, and they are therefore pleasing to the users of the products.

Mobile telephones are user terminals for mobile communications, and they offer people a rapid and convenient form of communication. At the same time, their external appearance design is gradually being made more fashionable, and their functional design too is tending more and more to become individualized. For example, in some currently available mobile telephone products, mobile telephone state messages indicating things such as web searches, low battery levels, packet arrivals, received brief news items, conversations in progress and unlistened-to calls, etc. can be given by different light-emitting diode light emission patterns produced by mobile telephone light-emitting diode message display systems. These light-emitting diode message display systems possess a rich variety of light emission functions which, as well as making it possible for various types of mobile telephone state messages such as noted above to be displayed in a convenient and directly viewable manner, also add more fashionable decorative lighting effects to mobile telephones. Further, users' demands for individualization are satisfactorily met, since users can edit light-emitting diode light emission patterns in accordance with their own preferences and can themselves set the relations between various mobile telephone states and different light-emitting diode light emission patterns.

In the above mobile telephone light-emitting diode message display systems, mobile telephone state messages occur both randomly and concurrently. For example, a packet may arrive or a brief news item may be received while a telephone conversation is in progress, or an indication that the battery is low may be given in the course of a web search. Therefore, the question of how to effect rational and effective scheduling of mobile telephone state messages and display them in the light-emitting diode message display system of a mobile telephone without any loss of mobile telephone state messages which need to be displayed constitutes a technological problem which requires a solution.

### SUMMARY

Under exemplary embodiments disclosed herein, a mobile telephone light-emitting diode display system display scheduling device and scheduling method are described, which provide rational and effective mobile telephone state message display scheduling for a mobile telephone light-emitting diode system.

Under one exemplary embodiment, a display scheduling device of a mobile telephone light-emitting diode display system is disclosed which includes a priority level grouping unit, a display queue unit, a timing queue unit and a scheduling program unit. Priority level groupings of mobile telephone states are preferably held in the priority level grouping unit, and each priority level grouping contains one or plural mobile telephone states. A display queue unit stores a queue of concurrent mobile telephone state messages, and the mobile telephone state messages in this display queue are ordered in accordance with their priority levels. A timing queue unit stores a queue of mobile telephone state messages which are preferably in the same priority level group and occur in succession, and the mobile telephone state messages in this timing queue are sequentially ordered in accordance with the timewise sequence of their occurrence. The above noted scheduling program unit effects scheduling in respect of displays of mobile telephone state messages in the light-emitting diode display system.

The length of the above noted display queue is preferably determined by the maximum number of mobile telephone states which can occur concurrently.

Under another exemplary embodiment, the storage area used by the above noted timing queue unit is dynamically allocated by a mobile telephone actuation system.

Under another exemplary embodiment, going on the basis of the ordering of mobile telephone state messages of one and the same priority level group in a timing queue in accordance with the timewise sequence of their occurrence, the queuing order of mobile telephone states in the timing queue is adjusted in accordance with the sequence of a user's responses to windows.

An exemplary mobile telephone light-emitting diode message display system scheduling method is also disclosed, where a scheduling program unit refers to mobile telephone state priority level groupings which are held in a priority level grouping unit and compares the priority level of a current mobile telephone state with the priority level of a mobile telephone state which is at the head of a queue in a display queue unit. If the priority level of the current mobile telephone state is higher than the priority level of the mobile telephone state which is at the head of this queue, the mobile telephone state messages which are in the display queue unit are successively shifted back, and the message of the current mobile telephone state is placed at the head of the queue and is displayed in the message display system. If the priority level of the current mobile telephone state is lower than the priority level of the mobile telephone state which is at the head of the queue the message of the current mobile telephone state is queued in the display queue unit and waits until it is displayed in the message display system. However, if the priority level of the current mobile telephone state is equal to the priority level of the mobile telephone state which is at the head of the queue, the message of the current mobile telephone state is queued in a timing queue unit and waits until it is displayed in the message display system.

According to one exemplary embodiment, the mobile telephone states comprise low battery level, packet arrival, alarm clock, brief news reception, brief news transmission in progress, screening protection, device turn-on, device turn-off, conversation in progress, unprocessed item, web search, cover turnover, cover closure, and charging; and these mobile telephone states are preferably divided into 7 groups.

According to another exemplary embodiment, the display queue length is preferably 5.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 illustrates a mobile telephone light-emitting diode message display system.

FIG. 2 shows the light-emitting diode distribution in the mobile telephone light-emitting diode message display system of FIG. 1;

FIG. 3 illustrates a display scheduling device of the mobile telephone light-emitting diode message display system under an exemplary embodiment;

FIG. 4 illustrates an exemplary display queue unit of the embodiment of FIG. 3;

FIG. 5 illustrates a display scheduling method of the mobile telephone light-emitting diode message display system under another exemplary embodiment.

### DETAILED DESCRIPTION

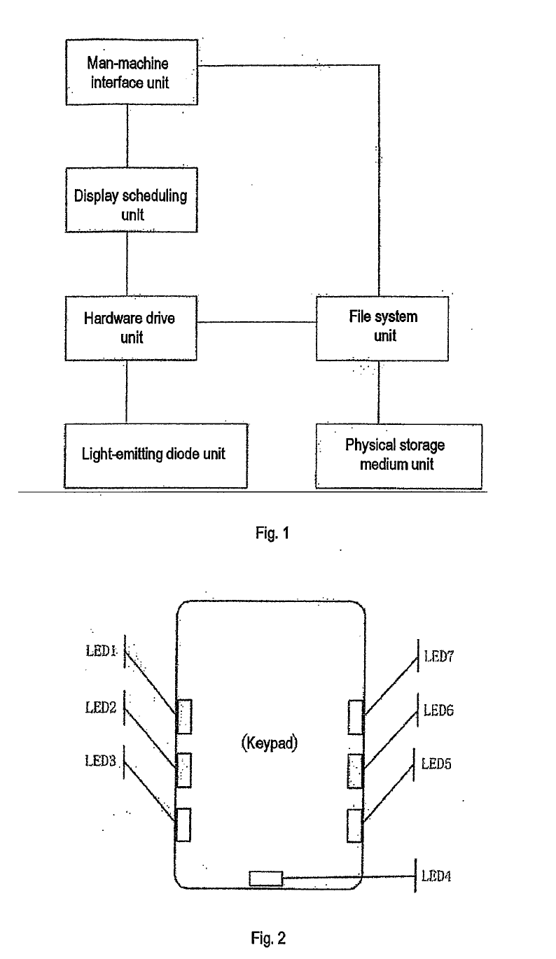

FIG. 1 shows an exemplary light-emitting diode message display system of a mobile telephone which comprises a physical storage medium unit, a file system unit, a man-machine interface unit, a display scheduling unit, a hardware drive unit and a light-emitting diode hardware unit. A light emission pattern file is stored in the physical storage medium unit, and this light emission pattern file is used to set the light emission patterns of the light-emitting diode hardware unit and contains light-emitting diode colors, light-emitting diode brightnesses and parameter settings such as light-emitting diode light emission sequences and light-emitting diode light emission maintenance times, etc. in correspondence to the number of light-emitting diodes. The file system unit includes a store by which the light emission pattern file is stored in the physical storage medium. The man-machine interface unit accesses the physical storage medium unit via the file system unit, and supports the editing and management of the light emission pattern file by the user and the setting, by the user himself, of the relations between electronic product states and light-emitting diode light emission patterns. The display scheduling device effects scheduling in respect of displays of mobile telephone state messages, and the hardware drive unit accesses the physical storage medium unit via the file system unit and uses the above noted light emission pattern file to drive light emission by the light-emitting diode hardware unit. What is shown in FIG. 2 is the light-emitting diode distribution of the mobile telephone light-emitting diode message display system, in which 7 light-emitting diodes (LED1, LED2, LED3, . . . , LED7) which are disposed around and at the outer side of the faceplate of a mobile telephone keypad constitute the light-emitting diode message display system's light-emitting diode hardware unit.

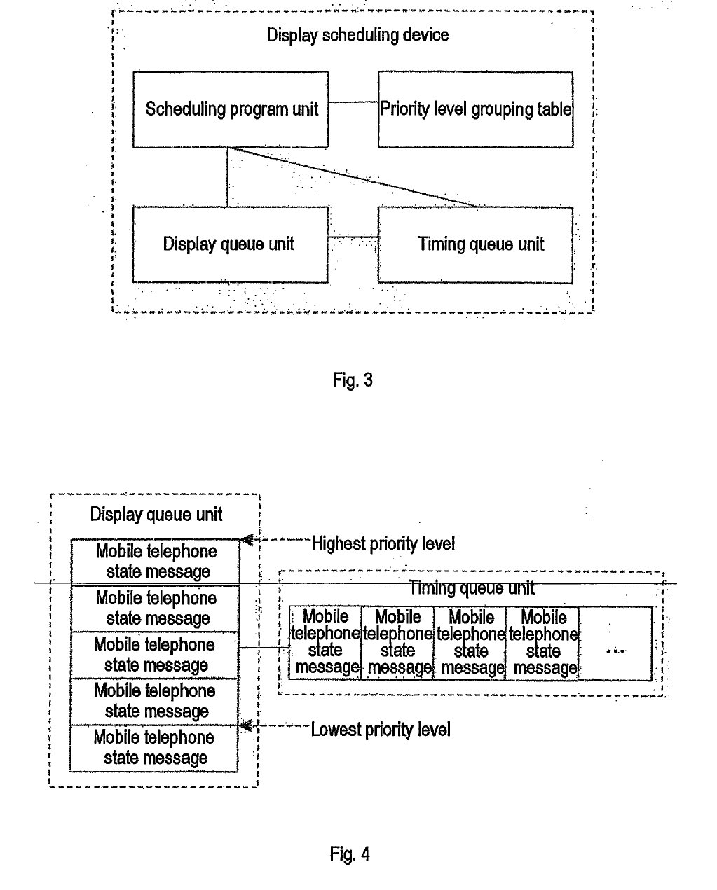

FIG. 3 shows an exemplary mobile telephone light-emitting diode message display system's display scheduling device. This provides the mobile telephone light-emitting diode message display system with scheduling of mobile telephone state messages, and it comprises a priority level grouping table unit, a display queue unit, a timing queue unit and a scheduling program unit. The priority level grouping table unit holds priority level groupings of mobile telephone states, and each priority level grouping contains one or plural mobile telephone states; a queue of concurrent mobile telephone state messages is stored in the display queue unit, the mobile telephone state messages in this display queue being ordered in accordance with their priority levels. The timing queue unit stores a queue of mobile telephone state messages which occur in succession and are in one and the same priority level group, the mobile telephone state messages in this timing queue being ordered in accordance with the sequence of the times when they occurred. the scheduling program unit effects scheduling of the displays of mobile telephone state messages in the mobile telephone light-emitting diode message display system.

Under an exemplary embodiment, the mobile telephone state priority level groupings held in the priority level grouping table unit are as indicated in Table 1, and the mobile telephone states therein comprise low battery levels, packet arrivals, an alarm clock, brief news item reception, brief news item transmission in progress, screening protection, device turn-on, device turn-off, telephone conversation in progress, unprocessed items, web searches, cover turnover, cover closure, and charging, these being divided into 7 groups in accordance with their priority levels, with the designation of priority level No. 1 indicating the highest priority level, and the designation of priority level No. 7 indicating the lowest priority level. As shown in FIG. 4, an exemplary length of the display queue in the display queue unit is 5. That is, at the maximum, 5 mobile telephone state messages with different priority levels are stored, this length being determined by the maximum number of mobile telephone states which can occur concurrently. The mobile telephone state message with the highest priority level is placed at the head of the queue, and the mobile telephone state message with the lowest priority level is placed at the end of the queue. The timing queue unit stores mobile telephone state messages which are in the same priority level group but have occurred in timewise succession, the storage area used by the timing queue unit is allocated dynamically by the mobile telephone's actuation system, mobile telephone state messages which occurred earlier are disposed at the front, mobile telephone state messages which occurred later are disposed at the rear, and, for example, if a new short news item is received at the time of transmission of a short news item, a short news item transmission message is placed at the front and a short news item reception message is placed at the rear in the timing queue unit.

TABLE 1

| Priority level (1 = highest) | Mobile telephone state |
|---|---|
| 1 | Battery Low |
| 2 | Packet arrival, alarm clock, short news item |
| | reception, short news item transmission in |
| | progress, screening protection, device |
| | actuation, device turnoff |
| 3 | Telephone conversation in progress |
| 4 | Unprocessed item |
| 5 | Web search |
| 6 | Cover turnover, cover closure |
| 7 | Charging |

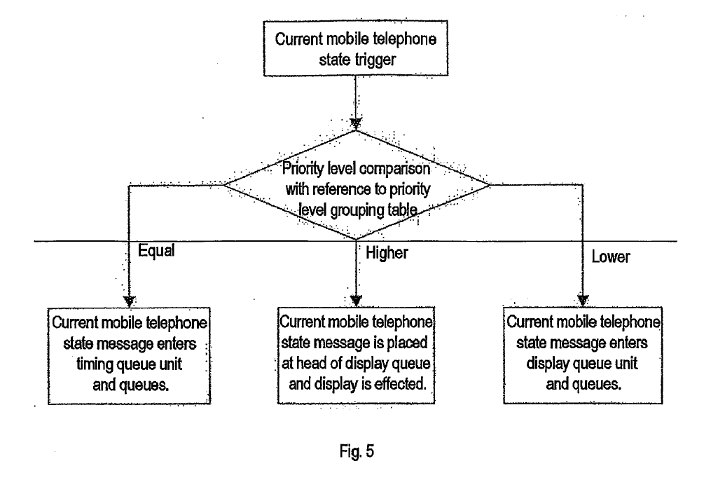

FIG. 5 shows an exemplary flowchart of a display scheduling method. Triggered by the currently occurring mobile telephone state, the above noted scheduling program unit refers to the mobile telephone state priority level groupings which are held in the priority level grouping table unit, and compares the priority level of the currently occurring mobile telephone state with the priority level of the mobile telephone state which is at the head of the queue in the display queue unit. If the priority level of the currently mobile telephone state is higher than the priority level of the mobile telephone state which is at the head of the queue, the mobile telephone state messages which are in the display queue unit are successively shifted back, and a current mobile telephone state message is placed at the head of the queue and is displayed in the message display’ system. If the priority level of the current mobile telephone state is lower than the priority level of the mobile telephone state which is at the head of the queue, a current mobile telephone state message is queued in the display queue and waits to be displayed in the message display system. If the priority level of the current mobile telephone state is equal to the priority level of the mobile telephone which is at the head of the queue, a current mobile telephone state message is queued in the timing queue unit and waits to be displayed in the message display unit.

The basic features of another exemplary embodiment are fundamentally the same as in the example above, but they differ in that, if the man-machine interface unit of the mobile telephone light-emitting diode message display system can support the participation of a user in the scheduling of mobile telephone state messages and so permit the user himself to adjust the order of display of mobile telephone state messages which are in the same priority level group but occur in timewise succession, then each of the mobile telephone states in one and the same priority level group can be linked to one window, this window can be displayed in the man-machine interface unit, and the user can himself, through the order of his responses to the window, adjust the order of display of mobile telephone state messages which occur in timewise succession and are in the same priority level group; at the same time, going on the basis of the above described mechanism whereby mobile telephone state messages which are in the same priority level group are queued in timing queues in accordance with the order of their timewise succession, a mechanism whereby the queue sequencing of mobile telephone states in timing queues is adjusted in accordance with the user's responses to windows such as the above is added, thereby realizing a function which supports the participation of the user in the scheduling of mobile telephone state messages.

It can be seen from the examples of implementation described above that the mobile telephone light-emitting diode message display system display scheduling and display method of the invention make it possible to effect rational and effective scheduling in respect of mobile telephone state messages which occur randomly and concurrently and cause them to be displayed in the mobile telephone light-emitting diode message display system, in addition to which the use of a display queue unit and a timing queue unit ensures that there is no loss of mobile telephone state messages which need to be displayed: further, a function which supports the participation of the user in the scheduling of mobile telephone state messages is realized thanks to the addition of a mechanism whereby the order of queuing of mobile telephone states in timing queues can be adjusted in accordance with the order of the user's responses to windows.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

1-8. (canceled)

9. A display scheduling device of a mobile telephone light-emitting diode display system, comprising:
a priority level grouping unit;
a display queue unit;
a timing queue unit; and a scheduling program unit, wherein priority level groupings of mobile telephone states are held in said priority level grouping unit, and each priority level grouping comprises one or plural mobile telephone states, said display queue unit stores a queue of concurrent mobile telephone state messages, and the mobile telephone state messages in this display queue are ordered in accordance with their priority levels, said timing queue unit stores a queue of mobile telephone state messages which are in the same priority level group and occur in succession, and the mobile telephone state messages in this timing queue are sequentially ordered in accordance with the time-related sequence of their occurrence; and wherein said scheduling program unit effects scheduling with respect to displays of mobile telephone state messages in said light-emitting diode display system.

10. The display scheduling device of a mobile telephone light-emitting diode message display system as claimed in claim 9, wherein the display queue length is determined by the maximum number of mobile telephone states which can occur concurrently.

11. The display scheduling device of a mobile telephone light-emitting diode message display system as claimed in claim 9, wherein the storage area used by said timing queue unit is dynamically allocated by a mobile telephone actuation system.

12. A practical scheduling device of a mobile telephone light-emitting diode message display system as claimed in claim 9, wherein going on the basis of the ordering of mobile telephone state messages of one and the same priority level group in a timing queue in accordance with the time-related sequence of their occurrence, the queuing order of mobile telephone states in the timing queue is adjusted in accordance with the sequence of a user's responses to windows.

13. A mobile telephone light-emitting diode message display system scheduling method, comprising the steps of:
generating mobile telephone state priority level groupings in a priority level grouping unit;
comparing a priority level of a current mobile telephone state with a priority level of a mobile telephone state which is at the head of a queue in a display queue unit; via a selecting program unit, wherein, if the priority level of the current mobile telephone state is higher than the priority level of the mobile telephone state which is at the head of this queue, mobile telephone state messages which are in said display queue unit are successively shifted back, and the message of the current mobile telephone state is placed at the head of the queue and is displayed in said message display system, and wherein, if the priority level of the current mobile telephone state is lower than the priority level of ‘the mobile telephone state which is at the head of the queue the message of the current mobile telephone state is queued in said display queue unit and waits until it is displayed in said message display system, and wherein, if the priority level of the current mobile telephone state is equal to the priority level of the mobile telephone state which is at the head of the queue, the message of the current mobile telephone state is queued in a timing queue unit and waits until it is displayed in said message display system.

14. The mobile telephone light-emitting diode message display system scheduling method as claimed in claim 13, wherein said mobile telephone states comprise low battery level, packet arrival, alarm clock, brief news reception, brief news transmission in progress, screening protection, device turn-on, device turn-off, conversation in progress, unprocessed item, web search, cover turnover, cover closure, and charging.

15. The mobile telephone light-emitting diode message display system scheduling method as claimed in claim 13, wherein said mobile telephone state priority levels are divided into 7 groups.

16. The mobile telephone light-emitting diode message display system scheduling method as claimed in claim 13, wherein the display queue length is 5.
